(19) United States
(12) Patent Application Publication
(10) Pub. No.: US 2007/0239332 A1
(43) Pub. Date: Oct. 11, 2007

(54) VEHICULAR ELECTRONIC CONTROL DEVICE

(75) Inventors: Masaya MORIKAMI, Tokyo (JP); Yoshiki Sugita, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: Mitsubishi Electric Corporation, Tokyo (JP)

(21) Appl. No.: 11/762,181

(22) Filed: Jun. 13, 2007

(30) Foreign Application Priority Data
Feb. 27, 2006 (JP) 2006-351740

(51) Int. Cl. G06F 7/00; G06F 19/00

(52) U.S. Cl. 701/36; 701/115; 709/232; 701/51

(57) ABSTRACT

A vehicular electronic control device includes plural electronic control units installed in the same vehicle. The plural electronic control units include at least one specific electronic control unit and at least one other electronic control unit. The specific electronic control unit and the other electronic control unit respectively include a memory. Specific data used by the specific electronic control unit are also stored in the memory of the other electronic control unit.

### BACKGROUND

1. Technical Field

The present invention relates to a vehicular electronic control device including plural electronic control units installed in the same vehicle.

2. Related Art

On-board devices such as automatic transmissions and engines installed in vehicles have variations in characteristics per product. For that reason, a vehicular electronic control device is constructed to usually store product-specific characteristic values of the on-board devices that have been combined and installed in the same vehicle and to control for alleviating variations.

In addition, a vehicular electronic control device is constructed to compensate for secular changes in the characteristics of the on-board devices by learning control and also add corrections depending on the running condition to improve running performance. For that reason, it is preferable, even when an electronic control device has been replaced, for these characteristic data and learning value data to be normally inherited in control by a new electronic control device without the characteristic data and learning data being lost, and technologies for inheriting these characteristic data and learning data have been introduced.

For example, in JP-A-5-215206, technology is introduced which stores characteristic values unique to an automatic transmission in a specific storage device attached to an automatic transmission body, and an electronic control device reads the characteristic values from the characteristic storage device. Further, in JP-A-2003-254418, technology is introduced which adheres an automatic transmission characteristic identification label to an automatic transmission body and, when an electronic control device is installed, reads the characteristics from the label and stores the characteristics in the electronic control device.

However, in JP-A-5-215206, it is necessary to newly add the characteristic storage device to be attached to the automatic transmission, and there is the problem that the cost increases. Further, in JP-A-2003-254418, there is the problem that the cost increases because label creating equipment and equipment for reading the characteristic values from the label and writing the characteristic values in the electronic control device become necessary. Further, when the characteristics become unable to be read from the label due to a worker forgetting the data inheritance work or the label becoming dirty or unstuck so that the data cannot be inherited, the installed on-board devices end up being controlled by characteristic data that are different from their characteristics, so that there has been the potential for control performance to be impaired.

### SUMMARY OF INVENTION

The present invention addresses these problems, and it is an object thereof to provide an improved vehicular electronic control device that can allow data to be inherited by a new electronic control unit without adding special elements or equipment when, for example, an electronic control unit has been replaced and the specific data of that electronic control unit have been lost.

A vehicular electronic control device according to this invention includes plural electronic control units installed in the same vehicle. The plural electronic control units include at least one specific electronic control unit and at least one other electronic control unit. The specific electronic control unit and the other electronic control unit respectively include a memory. Specific data used by the specific electronic control unit are also stored in the memory of the other electronic control unit.

In the vehicular electronic control device according to this invention, even when specific data used by the specific electronic control unit are lost due to replacement of that specific electronic control unit, for example, the specific data stored in the other electronic control unit are used in control by a new electronic control unit without adding special elements or equipment, so that the specific data can be inherited.

The foregoing and other objects, features, aspects, and advantages of the present invention will become more apparent from the following detailed description of the present invention when taken in conjunction with the accompanying drawings.

### BRIEF DESCRIPTION OF THE DRAWINGS

Exemplary embodiments of the present invention will be described in detail with reference to the following figures, wherein:

FIG. 1 is a block diagram showing a first exemplary embodiment of a vehicular electronic control device according to this invention;

FIG. 2 is a graph showing hydraulic pressure characteristic data of an automatic transmission in the first exemplary embodiment;

FIG. 3 is a block diagram showing a second exemplary embodiment of the vehicular electronic control device according to this invention;

FIG. 4 is a flowchart of specific data processing in the second exemplary embodiment;

FIG. 5 is a flowchart of specific data selection of the second exemplary embodiment;

FIG. 6 is block diagram showing a third exemplary embodiment of the vehicular electronic control device according to this invention; and

FIG. 7 is a flowchart of specific data selection of the third exemplary embodiment.

### DETAILED DESCRIPTION

Exemplary embodiments of a vehicular electronic control device according to this invention will be described below with reference to the drawings.

### First Exemplary Embodiment

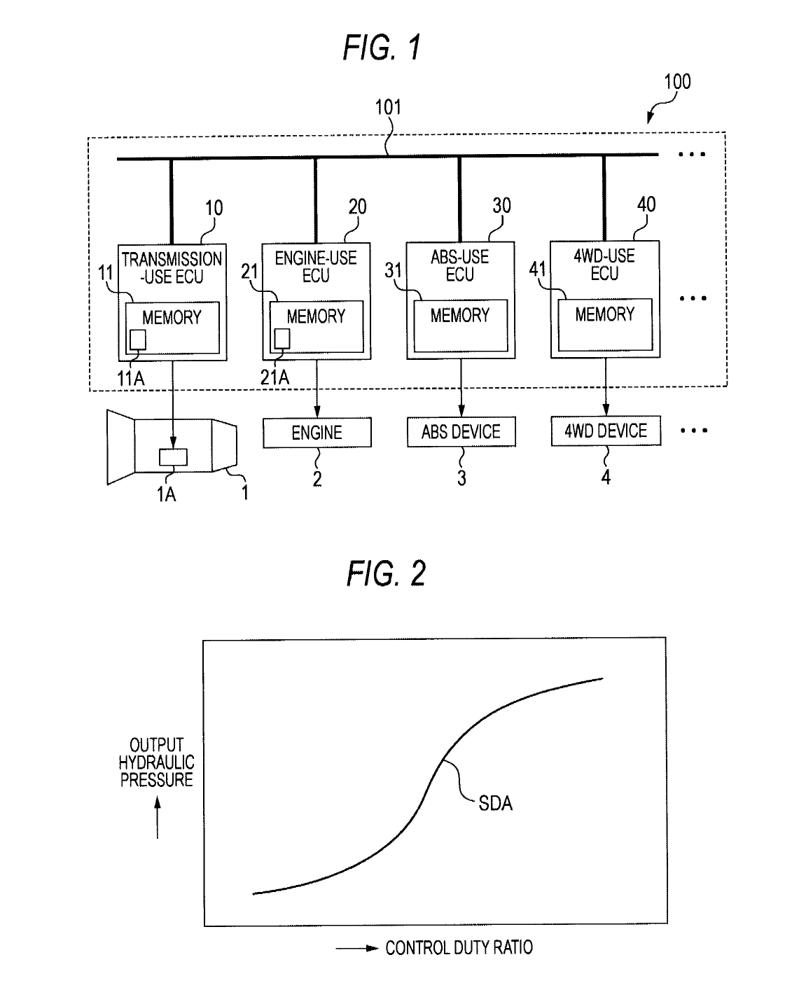

FIG. 1 is a block diagram showing a first exemplary embodiment of the vehicular electronic control device according to this invention. In FIG. 1, the vehicular electronic control device is represented by numeral 100. The vehicular electronic control device 100 is an electronic control device installed in one predetermined vehicle such as an automobile. The vehicular electronic control device 100 includes plural electronic control units 10, 20, 30, 40, and so on. The electronic control units 10, 20, 30, 40, and so on are installed in the same predetermined vehicle. The control units 10, 20, 30, 40, and so on are interconnected by an in-vehicle LAN 101. The electronic control unit 10 will be called a specific electronic control unit, and the electronic control units 20, 30, 40, and so on will be called other electronic control units.

In the first exemplary embodiment, the specific control unit 10 is a transmission-use electronic control unit, for example, is connected to an automatic transmission 1 installed in the predetermined vehicle, and controls the automatic transmission 1. The automatic transmission 1 is a well-known hydraulically controlled automatic transmission and houses a hydraulically controlled actuator 1A. The transmission-use electronic control unit 10 controls the actuator 1A. The transmission-use electronic control unit 10 includes an unillustrated CPU together with a memory 11, and various kinds of control data for controlling the automatic transmission 1 are stored in the memory 11.

The memory 11 includes a memory portion 11A, and the memory portion 11A is configured to use part of the memory area of the memory 11. Specific data SD that need to be inherited even when the transmission-use electronic control unit 10 is replaced are stored in the memory portion 11A. The specific data SD stored in the memory portion 11A of the transmission-use electronic control unit 10 will be called specific data SD1. The specific data SD1 stored in the memory portion 11A are used in the transmission-use electronic control unit 10 to control the automatic transmission 1.

The specific data SD1 stored in the memory portion 11A of the specific electronic control unit 10—that is, the transmission-use electronic control unit—include hydraulic pressure characteristic data SDA and shift timing control data SDB in the actuator 1A of the automatic transmission 1. The actuator 1A of the hydraulically controlled automatic transmission 1 is well known, so detailed description thereof will be omitted, but it regulates the control duty ratio of a solenoid to control output hydraulic pressure and automatically controls the shift gear ratio on the basis of the output hydraulic pressure. The hydraulic pressure characteristic data SDA included in the specific data SD1 are hydraulic pressure characteristic data representing the output hydraulic pressure with respect to the control duty ratio of the solenoid in the actuator 1A.

FIG. 2 is a graph showing the hydraulic pressure characteristic data SDA, with the horizontal axis representing the control duty ratio and the vertical axis representing the output hydraulic pressure. As is apparent from FIG. 2, the hydraulic pressure characteristic data SDA have a nonlinear characteristic, the hydraulic pressure characteristic data SDA have variations in characteristics in response to each individual automatic transmission 1, and the hydraulic pressure characteristic data SDA stored in the memory portion 11A correspond to the hydraulic pressure characteristics of the specific automatic transmission 1 installed in the predetermined vehicle. Further, the shift timing control data SDB are learning data that judge the shift timing of the preference of a driver from tendencies of operation in the predetermined vehicle and perform control of the shift gear ratio.

In the first exemplary embodiment, the electronic control unit 20 is an engine-use electronic control unit, for example, is connected to an engine 2 installed in the predetermined vehicle, and controls the engine 2. As is well known, the engine-use electronic control unit 20 performs ignition control, air intake control, and air exhaust control of the engine 2, for example. The engine-use electronic control unit 20 includes an unillustrated CPU together with a memory 21, and various kinds of data used to control the engine 2 are stored in the memory 21.

The memory 21 includes a predetermined memory portion 21A, and the memory portion 21A is configured to use part of the memory area of the memory 21. Specific data SD that need to be inherited even when the specific electronic control unit 10—that is, the transmission-use electronic control unit 10—is replaced are stored in the memory portion 21A. The specific data SD stored in the memory portion 21A will be called specific data SD2. The specific data SD2 are basically the same as the specific data SD1 stored in the memory portion 11A of the transmission-use electronic control unit 10 and include the same hydraulic pressure characteristic data SDA and shift timing control data SDB as in the specific data SD1.

In the first exemplary embodiment, the electronic control unit 30 is an ABS-use electronic control unit, for example, is connected to an ABS device 3 installed in the predetermined vehicle, and controls the ABS device 3. As is well known, the ABS device 3 is an anti-lock brake system that performs control to prevent the brakes from locking and apply appropriate braking force to the vehicle when sudden braking is applied to the vehicle, for example. The ABS-use electronic control unit 30 includes an unillustrated CPU together with a memory 31, and various kinds of data used to control the ABS device 3 are stored in the memory 31.

In the first exemplary embodiment, the electronic control unit 40 is a 4WD-use electronic control unit, for example, is connected to a 4WD device 4 installed in the predetermined vehicle, and controls the 4WD device 4. As is well known, the 4WD device 4 controls the four-wheel drive of the predetermined vehicle. The 4WD-use electronic control unit 40 includes an unillustrated CPU together with a memory 41, and various kinds of data used to control the 4WD device 4 are stored in the memory 41.

The hydraulic pressure characteristic data SDA and the shift timing control data SDB included in the specific data SD1 stored in the memory portion 11A of the specific electronic control device 10—that is, the transmission-use electronic control unit 10—are lost when the transmission-use electronic control unit 10 is replaced, but the specific data SD1 are data that need to be inherited by the next new transmission-use electronic control unit 10 even when the transmission-use electronic control unit 10 is replaced. In the vehicular electronic control device 100 of the first exemplary embodiment, the memory portion 21A is set in the memory 21 of the other electronic control unit 20 and the specific data SD2 that are basically the same as the specific data SD1 stored in the memory portion 11A are stored in the memory portion 21A in order to allow the specific data to be inherited even when the specific electronic control unit 10 is replaced.

The electronic control units 10, 20, 30, 40, and so on are interconnected by the in-vehicle LAN 101, so that when the specific data SD1 stored in the memory portion 11A of the transmission-use electronic control unit 10 have been corrected by learning, for example, the specific data SD2 stored in the memory portion 21A of the other electronic control unit 20 are also corrected at the same time so that the specific data SD1 and the specific data SD2 stored in the memory portions 11A and 21A are basically always mutually the same data.

Consequently, in the first exemplary embodiment, even if the specific electronic control unit 10—that is, the transmission-use electronic control unit 10—is replaced and the specific data SD1 stored in the memory portion 11A are lost, the specific data SD2 stored in the memory portion 21A of the other electronic control unit 20 are transmitted through the in-vehicle LAN 101 to the new transmission-use electronic control unit 10 and the new transmission-use electronic control unit 10 uses the data to control the automatic transmission 1, so that the specific data SD2 can be inherited by the new transmission-use electronic control unit 10. The specific data SD2 are stored in the memory portion 11A of the replaced new electronic control unit 10, and the replaced new electronic control unit 10 uses the specific data SD2 stored in the memory portion 11A to control the automatic transmission 1, so that the specific data SD2 can be inherited by the new electronic control unit 10.

Further, in the first exemplary embodiment, the specific data SD2 are stored in the memory portion 21A configured to utilize part of the memory area of the memory 21 in the other electronic control unit 20 other than the transmission-use electronic control unit 10, so it is not necessary to add special elements or equipment, and the manufacturing cost can be reduced because the storage device and equipment required by conventional technology are not needed. Further, because work such as replacement of the specific data SD by a worker is not required, inheritance of the specific data SD by the replaced new transmission-use electronic control unit 10 is not forgotten, and the burden on the worker can also be alleviated.

### Second Exemplary Embopdiment

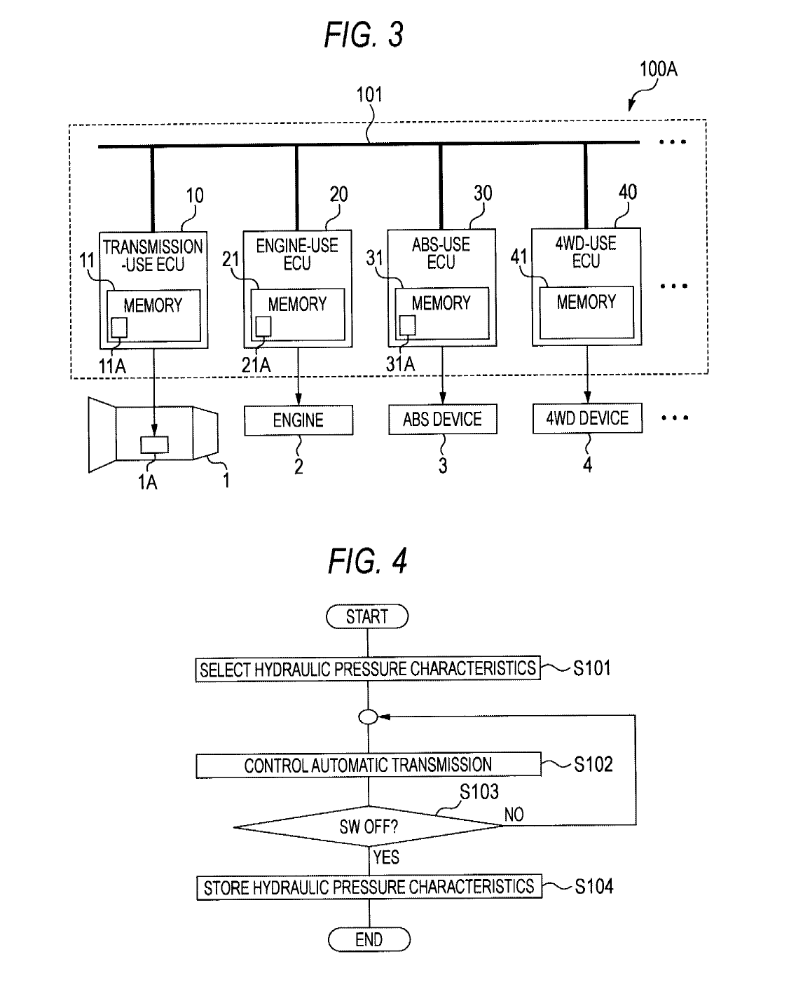

FIG. 3 is a block diagram showing a second exemplary embodiment of the vehicular electronic control device according to this invention. Similar to the vehicular electronic control device 100 of the first exemplary embodiment, a vehicular electronic control device 100A in the second exemplary embodiment includes plural electronic control units 10, 20, 30, 40, and so on. In the vehicular electronic control device 1OOA of the second exemplary embodiment, similar to the electronic control unit 20, a memory portion 31A is set in the memory 31 of the electronic control unit 30 and specific data SD3 are stored in the memory portion 31A. The rest is configured in the same manner as in the first exemplary embodiment.

The sets of specific data SD2 and SD3 stored in the memory portions 21A and 31A are both basically the same as the specific data SD1 stored in the memory portion 11A of the specific electronic control unit 10. These sets of specific data SD1, SD2, and SD3 respectively include the hydraulic pressure characteristic data SDA and the shift timing control data SDB in the actuator 1A of the automatic transmission 1. The hydraulic pressure characteristic data SDA stored in the memory portions 11A, 21A, and 31A correspond to the hydraulic pressure characteristics of the specific automatic transmission 1 installed in the predetermined vehicle. Further, the shift timing control data SDB are learning data that judge the shift timing of the preference of a driver from tendencies of operation in the predetermined vehicle and perform control of the shift gear ratio.

The electronic control units 10, 20, 30, 40, and so on are interconnected by the in-vehicle LAN 101, so that when the specific data SD1 stored in the memory portion 11A of the transmission-use electronic control unit 10 have been corrected by learning, for example, the specific data SD2 and SD3 stored in the memory portions 21A and 31A of the other electronic control units 20 and 30 are also corrected at the same time so that the specific data SD1, SD2, and SD3 stored in the memory portions 11A, 21A, and 31A are basically always mutually the same data.

Consequently, in the second exemplary embodiment, even when the specific electronic control unit 10—that is, the transmission-use electronic control unit 10—is replaced and the specific data SD1 stored in the memory portion 11A are lost, the specific data SD2 or SD3 stored in the memory portion 21A or 31A of the other electronic control unit 20 or 30 are transmitted through the in-vehicle LAN 101 to the new transmission-use electronic control unit 10 and the new transmission-use electronic control unit 10 uses the data to control the automatic transmission 1, so that the specific data SD can be inherited by the new transmission-use electronic control unit 10. The specific data SD2 or SD3 are stored in the memory portion 11A of the replaced new electronic control unit 10, and the replaced new electronic control unit 10 uses the specific data SD2 or SD3 stored in the memory portion 11A to control the automatic transmission 1, so that the specific data SD can be inherited by the new electronic control unit 10.

Further, in the second exemplary embodiment, the specific data SD2 and SD3 are stored in the memory portions 21A and 31A configured to utilize part of the memory areas of the memories 21 and 31 in the other electronic control units 20 and 30 other than the transmission-use electronic control unit 10, so it is not necessary to add special elements or equipment, and the manufacturing cost can be reduced because the storage device and equipment required by conventional technology are not needed. Further, because work such as replacement of the specific data SD by a worker is not required, inheritance of the specific data SD by the replaced new transmission-use electronic control unit 10 is not forgotten, and the burden on the worker can also be alleviated.

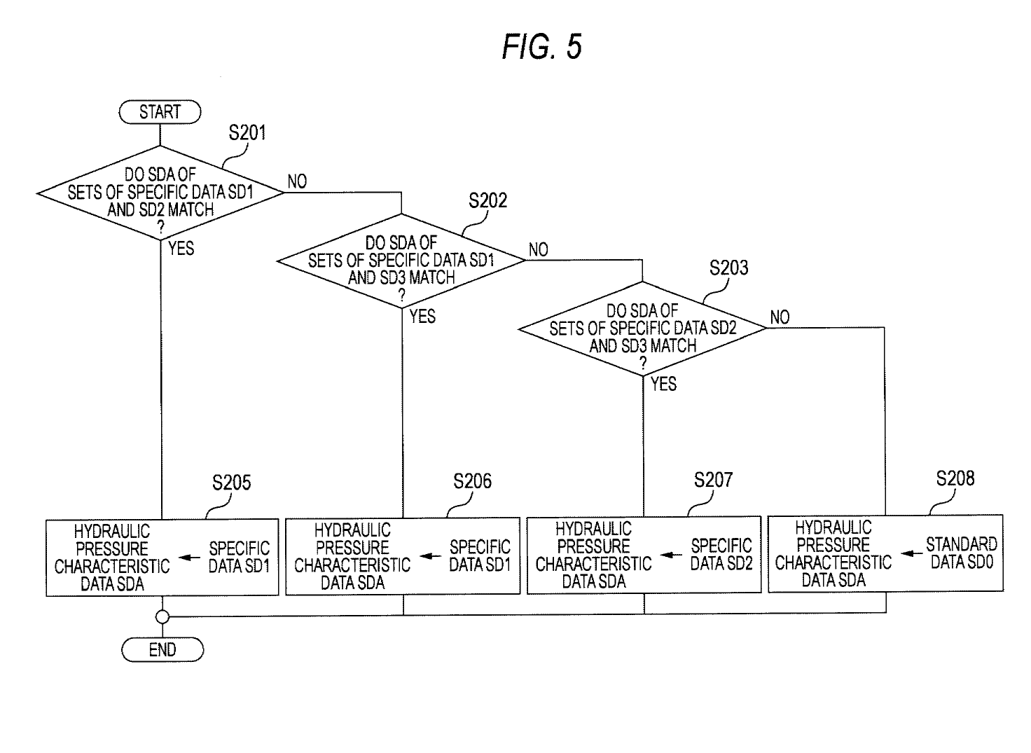

The second exemplary embodiment can also be configured to perform high-precision specific data processing using the three sets of specific data SD1, SD2, and SD3. FIG. 4 is a flowchart showing high-precision specific data processing in the second exemplary embodiment, and FIG. 5 is a flowchart of specific data selection in FIG. 4.

FIG. 4 is a flowchart of high-precision processing with respect to the hydraulic pressure characteristic data SDA included in the specific data SD. The shift timing control data SDB are also processed by a flowchart that is the same as the flowchart shown in FIG. 4. The flowchart of FIG. 4 is implemented by switching ON an ignition switch.

Turning now to FIG. 4, first, in step S101, the specific data SD1, SD2, and SD3 stored in the memory portions 11A, 21A, and 31A of the electronic control units 10, 20, and 30 are used to select the hydraulic pressure characteristic data SDA. When appropriate hydraulic pressure characteristic data SDA cannot be selected from the specific data SD1, SD2, and SD3, then standard hydraulic pressure characteristic data SDO are set as the hydraulic pressure characteristic data SDA.

In step S102, the selected hydraulic pressure characteristic data SDA are utilized to control the automatic transmission 1. For example, when the solenoid of the actuator 1A is controlled by the control duty ratio of a standard value, and in the case of hydraulic pressure characteristics of the automatic transmission 1 where the output hydraulic pressure is lower than the standard hydraulic pressure value, then the output hydraulic pressure is raised to correct the control duty ratio to the standard hydraulic pressure, and in the case of hydraulic pressure characteristics of the automatic transmission 1 where the output hydraulic pressure is higher than the standard hydraulic pressure, then the output hydraulic pressure is lowered to correct the control duty ratio to the standard hydraulic pressure value, so that shift control is performed such that differences do not arise in control performance depending on the unique hydraulic pressure characteristics of the automatic transmission 1, and the flow proceeds to step S103.

In step S103, it is determined whether or not the ignition switch has been switched OFF. When the ignition switch has been switched OFF, then the determination result of step S103 becomes YES and the flow proceeds to step S104, and when the ignition switch is ON, then the determination result of S103 becomes NO and the flow returns to step S102. During the period while the ignition switch is ON, the shift control of step S102 is repeated.

In step S104, the hydraulic pressure characteristic data SDA selected in step S101 are stored in the memory portions 11A, 21A, and 31A of the electronic control units 10, 20, and 30, and processing ends. Due to step S104, the sets of specific data SD1, SD2, and SD3 stored in the memory portions 11A, 21A, and 31A of the electronic control units 10, 20, and 30 become basically the same data.

FIG. 5 shows a detailed flowchart of the selection of the hydraulic pressure characteristic data SDA in step S101 of FIG. 4. The shift timing control data SDB are also selected by a flowchart that is the same as the flowchart shown in FIG. 5.

Turning now to FIG. 5, first, in step S201, the specific data SD1 and the specific data SD2 in the memory portions 11A and 21A of the electronic control units 10 and 20 are compared with each other to determine whether or not they match. When the determination result of step S201 is YES, then the flow proceeds to step S205, and in step S205, the specific data SD1 are selected as the hydraulic pressure characteristic data SDA and processing ends. When the specific data SD1 have been lost due to replacement of the electronic control unit 10, or when the specific data SD2 have become abnormal data due to a writing error or the like, then the specific data SD1 and the specific data SD2 do not match, the determination result of step S201 becomes NO, and the flow proceeds to the next step S202.

In step S202, the specific data SD1 and the specific data SD3 in the memory portions 11A and 31A of the electronic control units 10 and 30 are compared with each other to determine whether or not they match. When the determination result of step S202 is YES, then the flow proceeds to step S206, and in step S206, the specific data SD1 are selected as the hydraulic pressure characteristic data SDA and processing ends. When the specific data SD1 have been lost due to replacement of the electronic control unit 10, or when the specific data SD3 have become abnormal data due to a writing error or the like, then the specific data SD1 and the specific data SD3 do not match, the determination result of step S202 becomes NO, and the flow proceeds to the next step S203.

In step S203, the specific data SD2 and the specific data SD3 in the memory portions 21A and 31A of the electronic control units 20 and 30 are compared with each other to determine whether or not they match. When the determination result of step S203 is YES, then the flow proceeds to step S207, and in step S207, the specific data SD2 are selected as the hydraulic pressure characteristic data SDA and processing ends. When the specific data SD2 and the specific data SD3 do not match, then the determination result of step S203 becomes NO and the flow proceeds to the next step S208. In step S208, the standard hydraulic pressure characteristic data SD0 set beforehand in the transmission-use electronic control unit 10 are set as the hydraulic pressure characteristic data SDA and processing ends.

In this manner, in the high-precision specific data processing of the second exemplary embodiment, two sets of specific data selected from among the sets of specific data SD1, SD2, and SD3 stored in the memory portions 11A, 21A, and 31A of the three electronic control units 10, 20, and 30 are sequentially compared to sequentially determine whether or not they match, and when they match, then the specific data SD1, SD2, and SD3 are selected as the hydraulic pressure characteristic data SDA. Consequently, selection of the hydraulic pressure characteristic data SDA can be performed with higher precision.

When the specific electronic control unit 10 has been replaced and the specific data SD1 have been lost, then the determination results of steps S201 and S202 both become NO, and in step S203, the specific data SD2 and the specific data SD3 are compared with each other, and when they match, then the specific data SD2 are selected as the hydraulic pressure characteristic data SDA. When the specific data SD2 and the specific data SD3 match, then the specific data SD are accurately inherited so that accurate specific data SD2 can be selected as the hydraulic pressure characteristic data SDA.

When the specific electronic control unit 10 has not been replaced, then in steps S201, S202, and S203, it is determined whether or not two of the sets of specific data SD1, SD2, and SD3 match, and when they match, then the specific data SD1 or SD2 are selected as the hydraulic pressure characteristic data SDA, so that even when one of the sets of specific data SD1, SD2, and SD3 have become abnormal due to a writing error or the like, for example, then accurate specific data can be selected as the hydraulic pressure characteristic data SDA on the basis of the two sets of specific data that are not abnormal.

In this manner, in the vehicular electronic control device 100A of the second exemplary embodiment, even when the specific data SD1 stored in the memory portion 11A of the transmission-use electronic control unit 10 are lost due to replacement of the transmission-use electronic control unit 10 that is a specific electronic control unit, the specific data SD of the installed automatic transmission 1 can be continued and obtained as is in the predetermined vehicle from the specific data SD2 and SD3 stored in the memory portions 21A and 31A of the other electronic control units 20 and 30, and the specific data SD can be inherited by the replaced new transmission-use electronic control unit 10. Consequently, even when the transmission-use electronic control unit 10 is replaced, the specific data SD that need to be inherited are not lost, the inherited specific data SD are used so that specific data SD that are the same as the data before replacement of the transmission-use electronic control unit 10 can be used to perform control, and control conforming to the characteristics unique to the automatic transmission 1 installed in the predetermined vehicle can be performed.

### Third Exemplary Embodiment

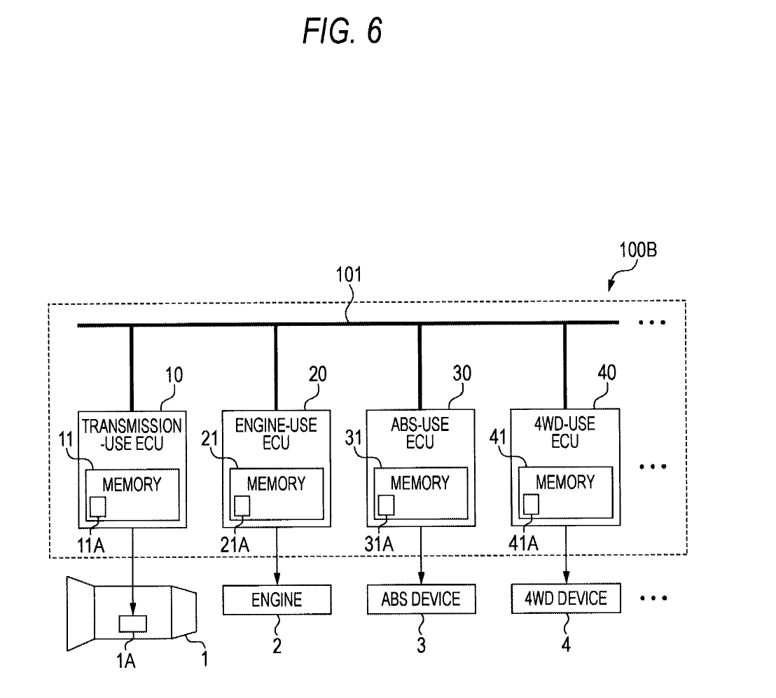

FIG. 6 is a block diagram showing a third exemplary embodiment of the vehicular electronic control device according to this invention. In a vehicular electronic control device 100B of the third exemplary embodiment, in addition to the electronic control units 20 and 30, a memory portion 41A is set in the memory 41 of the electronic control unit 40 and specific data SD4 are stored in the memory portion 41A. The rest is configured in the same manner as in the vehicular electronic control device 100A of the second exemplary embodiment.

In the third exemplary embodiment, the sets of specific data SD2, SD3, and SD4 stored in the memory portions 21A, 31A, and 41A are all basically the same as the specific data SD1 stored in the memory portion 11A of the specific electronic control unit 10. The sets of specific data SD1, SD2, SD3, and SD4 respectively include the hydraulic pressure characteristic data SDA and the shift timing control data SDB in the actuator 1A of the automatic transmission 1. The hydraulic pressure characteristic data SDA stored in the memory portions 11A, 21A, 31A, and 41A correspond to the hydraulic pressure characteristics of the specific automatic transmission 1 installed in the predetermined vehicle. Further, the shift timing control data SDB are learning data that judge the shift timing of the preference of a driver from tendencies of operation in the predetermined vehicle and perform control of the shift gear ratio.

In the third exemplary embodiment also, the electronic control units 10, 20, 30, 40, and so on are interconnected by the in-vehicle LAN 101, so that when the specific data SD1 stored in the memory portion 11A of the transmission-use electronic control unit 10 have been corrected by learning, for example, the specific data SD2, SD3, and SD4 stored in the memory portions 21A, 31A, and 41A of the other electronic control units 20 are also corrected at the same time so that the specific data SD1, SD2, SD3, and SD4 stored in the memory portions 11A, 21A, 31A, and 41A are basically always mutually the same data.

Consequently, in the third exemplary embodiment, even if the specific electronic control unit 10—that is, the transmission-use electronic control unit 10—is replaced and the specific data SD1 stored in the memory portion 11A are lost, the specific data SD2, SD3, or SD4 stored in the memory portion 21A, 31A, or 41A of the other electronic control unit 20, 30, or 40 are transmitted through the in-vehicle LAN 101 to the new transmission-use electronic control unit 10 and the new transmission-use electronic control unit 10 uses the data to control the automatic transmission 1, so that the specific data SD can be inherited by the new transmission-use electronic control unit 10. The specific data SD2, SD3, or SD4 are stored in the memory portion 11A of the replaced new electronic control unit 10, and the replaced new electronic control unit 10 uses the specific data SD2, SD3, or SD4 stored in the memory portion 11A to control the automatic transmission 1, so that the specific data SD can be inherited by the new electronic control unit 10.

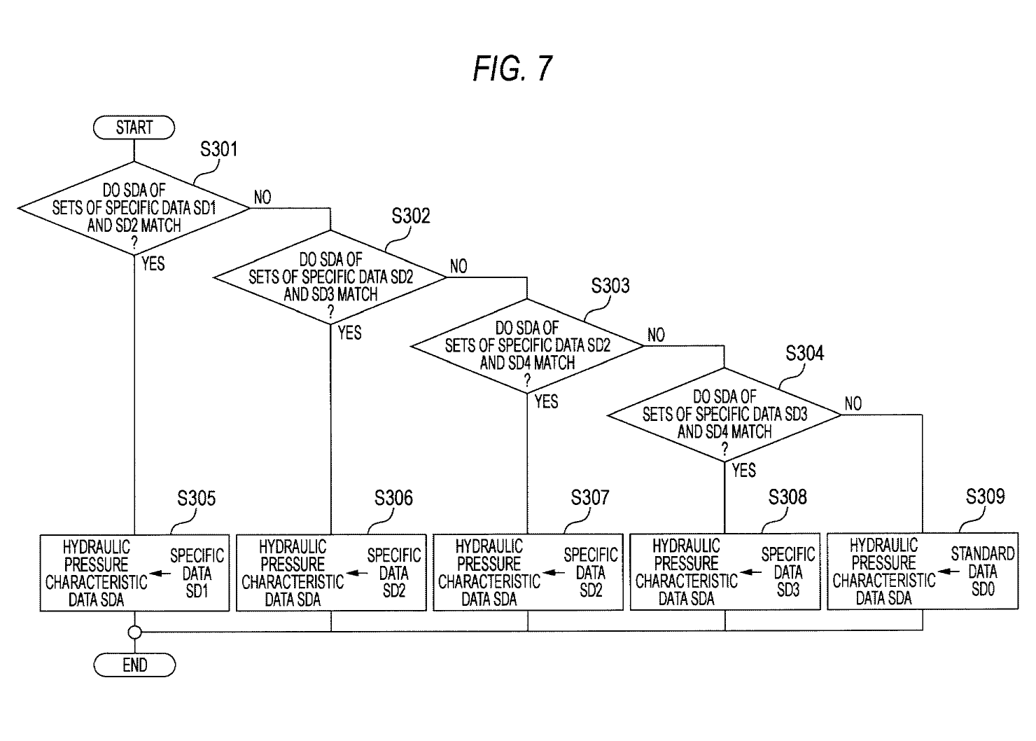

The third exemplary embodiment can also be configured to use the four sets of specific data SD1, SD2, SD3, and SD4 to perform high-precision specific data processing. In this high-precision specific data processing, high-precision specific data processing is executed by a flowchart that is the same as FIG. 4. In the high-precision specific data processing of FIG. 4, the flowchart of specific data selection shown in FIG. 7 is executed. FIG. 7 shows a flowchart of hydraulic pressure characteristic data selection processing executed by step S101 when performing the high-precision specific data processing shown in FIG. 4 in the third exemplary embodiment. The shift timing control data SDB are also processed in the same manner as in FIG. 4 and FIG. 7.

Turning now to FIG. 7, first, in step S301, the specific data SD1 and the specific data SD2 in the memory portions 11A and 21A of the electronic control units 10 and 20 are compared with each other to determine whether or not they match. When the determination result of step S301 is YES, then the flow proceeds to step S305, and in step S305, the specific data SD1 are selected as the hydraulic pressure characteristic data SDA and processing ends. When the specific data SD1 and the specific data SD2 are different as a result of the specific data SD1 being lost due to replacement of the transmission-use electronic control unit 10, for example, then the determination result of step S301 becomes NO and the flow proceeds to the next step S302.

In step S302, the specific data SD2 and the specific data SD3 in the memory portions 21A and 31A of the electronic control units 20 and 30 are compared with each other to determine whether or not they match. When the determination result of S302 is YES, then the flow proceeds to step S306, and in step S306, the specific data SD2 are selected as the hydraulic pressure characteristic data SDA and processing ends. When the specific data SD2 and the specific data SD3 do not match, then the determination result of step S302 becomes NO and the flow proceeds to the next step S303 to determine which of the sets of specific data SD2 and SD3 is a normal value.

In step S303, the specific data SD2 and the specific data SD4 in the memory portions 21A and 41A of the electronic control units 20 and 40 are compared with each other to determine whether or not they match. When the determination result of step S303 is YES, then the flow proceeds to step S307, and in step S307, the specific data SD2 are selected as the hydraulic pressure characteristic data SDA and processing ends. When the specific data SD2 and the specific data SD4 do not match, then the determination result of step S303 becomes NO and the flow proceeds to the next step S304.

In step S304, the specific data SD3 and the specific data SD4 in the memory portions 31A and 41A of the electronic control units 30 and 40 are compared with each other to determine whether or not they match. When the determination result of step S304 is YES, then the flow proceeds to step S308, and in step S308, the specific data SD3 are selected as the hydraulic pressure characteristic data SDA and processing ends. When the specific data SD3 and the specific data SD4 do not match, then the determination result of step S304 becomes NO and the flow proceeds to step S309. In step S309, the standard hydraulic pressure characteristic data SDO set beforehand in the transmission-use electronic control unit 10 are set as the hydraulic pressure characteristic data SDA and processing ends.

In this manner, the specific data SD used by the transmission-use electronic control unit 10 are stored in the other three electronic control units 20, 30, and 40 other than the transmission-use electronic control unit 10 that is a specific electronic control unit, so that when the transmission-use electronic control unit 10 is replaced, the specific data SD can be made into more accurate data and inherited. In a configuration where the specific data SD are stored in one other electronic control unit other than the transmission-use electronic control unit 10, when the specific data stored in the other one electronic control unit have become abnormal data due to a writing error or the like, there is the potential for accurate specific data SD to be lost. Further, in a configuration where the specific data SD are stored in two electronic control units other than the transmission-use electronic control unit 10, when the specific data SD stored in one electronic control unit of the two electronic control units other than the transmission-use electronic control unit have become abnormal data, it cannot be judged which of the sets of specific data stored in the two electronic control units other than the transmission-use electronic control unit 10 are accurate data. In a configuration where the specific data SD are stored in the other three electronic control units 20, 30, and 40 other than the transmission-use electronic control unit 10, when one of the sets of specific data SD stored in the three electronic control units other than the transmission-use electronic control unit 10 have become abnormal data due to a writing error or the like, it becomes possible to judge the specific data SD that have become abnormal by checking whether or not the remaining two sets of specific data SD match, so that accurate specific data SD can be reliably inherited by the replaced new transmission-use electronic control unit 10.

In this manner, in the vehicular electronic control device 100B of the third exemplary embodiment, even when the specific data SD1 stored in the memory portion 11A of the transmission-use electronic control unit 10 are lost due to replacement of the transmission-use electronic control unit 10 that is a specific electronic control unit, the specific data SD of the automatic transmission 1 installed in the predetermined vehicle can be obtained as is from the specific data SD2, SD3, and SD4 stored in the memory portions 21A, 31A, and 41A of the other electronic control units 20, 30, and 40, and the specific data SD can be inherited by the replaced new transmission-use electronic control unit 10. Consequently, even when the transmission-use electronic control unit 10 is replaced, the specific data SD that need to be inherited are not lost, the inherited specific data SD are used so that specific data SD that are the same as the data before replacement of the transmission-use electronic control unit 10 can be used to perform control, and control conforming to the characteristics unique to the automatic transmission 1 installed in the predetermined vehicle can be performed.

Further, in the third exemplary embodiment, the specific data SD2, SD3, and SD4 are stored in the memory portions 21A, 31A, and 41A configured to utilize part of the memory areas of the memories 21, 31, and 41 in the other electronic control units 20, 30, and 40 other than the transmission-use electronic control unit 10, so it is not necessary to add special elements or equipment, and the manufacturing cost can be reduced because the storage device and equipment required by conventional technology are not needed. Further, because work such as replacement of the specific data SD by a worker is not required, inheritance of the specific data SD by the replaced new transmission-use electronic control unit 10 is not forgotten, and the burden on the worker can also be alleviated.

Here, in the first, second, and third exemplary embodiments, a case was described where the specific data SD unique to the automatic transmission 1 were stored in the engine-use electronic control unit 20, the ABS-use electronic control unit 30, and the 4WD-use electronic control unit 40, but the specific data SD are not limited to specific data SD unique to the automatic transmission 1. For example, specific data unique to an on-vehicle device other than the automatic transmission 1, such as the engine 2, the ABS device 3, or the 4WD device 4, or learning data may be used as the specific data SD, and the specific data SD may be stored in a memory portion of another electronic control unit so that the specific data SD can be inherited in the same manner.

Further, in the first, second, and third exemplary embodiments, a case was described where the specific data SD unique to the automatic transmission 1 were stored in the engine-use electronic control unit 20 and the like, but the specific data SD are not limited to the specific data SD of the automatic transmission 1; conversely, the characteristics unique to the engine 2 may be used as the specific data SD and stored in the memory portion 11A of the transmission-use electronic control unit 10 so that data that need to be inherited by the electronic control units connected by the in-vehicle LAN are stored in each other. The type of the electronic control unit may be anything as long as it is one that stores, in another electronic control unit, data for which inheritance relating to an installed on-board device is necessary.

Further, in the first, second, and third exemplary embodiments, inheritance of the specific data SD was described in a case where the specific data SD were lost due to replacement of the electronic control unit 10, but inheritance is not limited to the time of replacement. The same configuration can also be given a backup function so that even when the specific data SD of an electronic control unit have changed due to the affects of device failure or strong static electricity, normal specific data SD are selected from specific data SD stored in another electronic control unit to perform control and the changed specific data are returned to normal.

Further, in the first, second, and third exemplary embodiments, the vehicular electronic control devices 100, 100A, and 100B can further include, other than the transmission-use electronic control unit 10, the engine-use electronic control unit 20, the ABS-use electronic control unit 30, and the 4WD-use electronic control use 40, other electronic control units such as an electrical power steering-use electronic control unit, a cruise control-use electronic control unit, a VSC-use electronic control unit, a traction control-use electronic control unit, and an electronic control brake-use electronic control unit. A VCS-use electronic control unit is an electronic control device that controls a VSC device (vehicle stability control device) for avoiding skidding of a vehicle. And in these other electronic control units, memory portions may be configured using part of the memory areas of their memories so that specific data SD can be stored in the memory portions. Further, these other electronic control units can also be used instead of the engine-use electronic control unit 20, the ABS-use electronic control unit 30, and the 4WD-use electronic control unit 40.

Various modifications and alterations of this invention will be apparent to those skilled in the art without departing from the scope and spirit of this invention, and it should be understood that this is not limited to the illustrative embodiments set forth herein.

What is claimed is:

1. A vehicular electronic control device including plural electronic control units installed in the same vehicle, wherein
the plural electronic control units include at least one specific electronic control unit and at least one other electronic control unit,
the specific electronic control unit and the other electronic control unit respectively include a memory, and
specific data used by the specific electronic control unit are also stored in the memory of the other electronic control unit.

2. The vehicular electronic control device according to claim 1, wherein the specific electronic control unit and the other electronic control unit are interconnected by an in-vehicle LAN.

3. The vehicular electronic control device according to claim 1, wherein the specific data are stored in the memory of the other electronic control unit and inherited in control by the specific electronic control unit even when the specific electronic control unit is replaced.

4. The vehicular electronic control device according to claim 1, wherein the plural electronic control units include at least one of the specific electronic control unit and plural other electronic control units, and the specific data are stored in memories of the plural other electronic control units.

5. The vehicular electronic control device according to claim 4, wherein the specific electronic control unit and the other plural electronic control units are interconnected by an in-vehicle LAN.

6. The vehicular electronic control device according to claim 4, wherein the plural electronic control units include at least one of the specific electronic control unit and at least three other electronic control units, and the specific data are stored in memories of the at least three other electronic control units.

7. The vehicular electronic control device according to claim 4, wherein the specific data are stored in the memories of the plural other electronic control units and inherited in control by the specific electronic control unit even when the specific electronic control unit is replaced.

8. The vehicular electronic control device according to claim 1, wherein the specific electronic control unit is a transmission-use electronic control unit that controls a transmission for performing shift operation on the basis of hydraulic pressure, and the specific data include hydraulic pressure characteristic data of the transmission.
